(19) United States
(12) Patent Application Publication
(10) Pub. No.: US 2025/0137571 A1
(43) Pub. Date: May 1, 2025

(54) Thermal Insulation System for Exhaust Gas Temperature Management

(71) Applicant: Zephyros, Inc., Romeo, MI (US)

(72) Inventors: Manish Taxak, Maharashtra (IN); Rajesh Pathare, Maharashtra (IN)

(21) Appl. No.: 18/834,814

(22) PCT Filed: Feb. 16, 2023
(86) PCT No.: PCT/US2023/013204

§ 371 Date: Jul. 31, 2024

(30) Foreign Application Priority Data
Feb. 17, 2022 (IN) 202231008347

(51) Int. Cl. F16L 59/02; F16L 9/18

(52) U.S. Cl. CPC F16L 59/029; F16L 9/18

(57) ABSTRACT

An article comprising a plurality of layers or in form of powder or slurry, the layers comprising: one or more nonwoven layers (16) of powder or slurry; wherein each of the one or more nonwoven layers or powder or slurry has a temperature resistance of about 800° C. or greater; and wherein the article is adapted to provide thermal insulation for an exhaust pipe. The layer is between an inner wall (14) and outer wall (12) of a double-wall exhaust pipe (10).

### FIELD

The present teachings generally relate to a multi-layered material for providing insulation, and more particularly, to an insulative material for providing passive thermal management for vehicle exhaust systems.

### BACKGROUND OF THE INVENTION

Many conventional vehicles, commercial and consumer-based, may include an internal combustion engine (ICE). Such engines require an exhaust system connected to the engine for removal of the gas and heat created by the engine during operation. However, the heat created by the engine may be expelled at significantly heightened temperatures through exhaust which may cause structural damage (e.g., prolonged exposure may result in stresses buildup), damage to electrical system and/or sensors and/or deformation to a conventional exhaust pipe.

To combat such issues, many exhaust pipes may be designed with a double-wall structure consisting of an outer pipe and an inner pipe, whereby an air gap is present between the outer and inner pipes. As a result, the double-wall structure may more effectively insulate against the high heat being expelled through the system to ensure structural integrity of the exhaust system and other systems in proximity to exhaust system. Such a design may also ensure that the heat expelled from the exhaust pipes is relatively cooler to prevent injury or damage in the surrounding area to the vehicle. However, the use of a conventional double-walled structure has proven to be unsuccessful in effectively retaining exhaust gas temperature so that the Selective Catalyst Convertor (SCR) can work efficiently.

To improve on the double-wall structure having an air gap, an insulative material may be positioned between the outer wall and the inner wall to create an additional barrier for exhaust heat to enable exhaust temperature retention for efficient operation of the SCR. However, conventional insulative materials often leave an air gap between the outer and inner walls that may create significant leakage (e.g., unwanted heat dissipation to the surrounding vehicle environment), may result in movement of the insulative material, or both. Similarly, the insulative material may often require minimal packaging thickness to effectively insulate and meet typical vehicle specification requirement, thereby increasing the overall thickness of the exhaust pipe. As a result, the exhaust pipe may incur an increased cost, increased manufacturing time, increase packaging constraints within the vehicle, or a combination thereof.

Thus, there remains a need for an improved exhaust system to effectively insulate against the extreme temperatures expelled from an engine while maintaining temperatures within the system for facilitating operation of an SCR. What is needed is a double-walled exhaust system having a multi-layered insulative material positioned therebetween. Additionally, there remains a need for an exhaust system having tighter packaging without a resultant performance drop-off. Therefore, what is needed is a double-walled exhaust pipe having a multi-layered insulative material with a significantly compressed material thickness to decrease the overall diameter of the exhaust pipe. Moreover, what is needed is a double-walled exhaust pipe that prevents leakage to the surrounding environment. Thus, what is needed is an air-tight double-walled exhaust pipe having a multi-layered insulative material positioned between the outer wall and the inner wall of the exhaust pipe.

### SUMMARY

The present teachings meet one or more of the present needs by providing an article comprising a plurality of layers, the layers comprising: (a) one or more nonwoven layers: wherein each of the one or more nonwoven layers has a temperature resistance of about 800° C. or greater; and wherein the article is adapted to provide thermal insulation for an exhaust pipe

The exhaust pipe may be a dual-walled pipe having an outer wall and an inner wall spaced apart from the outer wall. The article may be positioned between the outer wall and the inner wall. The article may abut an outer surface of the inner wall. The article may be spaced apart from an inner surface of the outer wall by an air gap. The article may abut an inner surface of the outer wall. The article may form an airtight seal between the outer wall and the inner wall. The article may be injected into the exhaust pipe as a slurry or a powder. The article may be pre-formed and inserted into the exhaust pipe.

Moreover, the present teachings meet one or more of the present needs by providing an exhaust pipe comprising: (A) an inner wall: (B) an outer wall spaced apart from the inner wall; and (C) an insulative material positioned between the inner wall and the outer wall, wherein the insulative material includes one or more nonwoven layers and has a temperature resistance of about 800° C. or greater.

The insulative material may abut an outer surface of the inner wall. The insulative material may abut an inner surface of the outer wall. The insulative material may form an airtight seal with the outer wall and the inner wall. Additionally, a fluid (e.g., an adhesive capable of withstanding high temperatures) may be injected between the outer wall and the inner wall to fill any cavity formed therebetween. The insulative material may be a slurry of material injected between the inner wall and the outer wall. The insulative material may include one or more surface layers. The surface layers may be a metallic material.

Moreover, the insulative material may be spaced apart from the outer wall by an air gap. The insulative material may also have a thickness of about 1 mm to about 10 mm, or even about 5 mm to about 7 mm. Additionally, the exhaust pipe having the insulative material may maintain a temperature along a length of the exhaust pipe during operation of within about 7° C. during operation.

Furthermore, the present teachings meet one or more of the present needs by providing: an improved exhaust system to effectively insulate against the extreme temperatures expelled from an engine; a double-walled exhaust system having a multi-layered insulative material positioned therebetween; an exhaust system having tighter packaging without a resultant performance drop-off: a double-walled exhaust pipe having a multi-layered insulative material with a significantly compressed material thickness to decrease the overall diameter of the exhaust pipe: a double-walled exhaust pipe that prevents leakage to the surrounding environment: an air-tight double-walled exhaust pipe having a multi-layered insulative material positioned between the outer wall and the inner wall of the exhaust pipe; or a combination thereof.

### BRIEF DESCRIPTION OF THE DRAWINGS

FIG. 1 is a sectional view of an exemplary exhaust pipe in accordance with the present teachings.

FIG. 2 is a section view of an exemplary exhaust pipe in accordance with the present teachings.

FIG. 3 is a sectional view of a manufacturing process of an exemplary exhaust pipe in accordance with the present teachings.

FIG. 4 is a perspective view of an exemplary insulative material adapted for an exhaust pipe in accordance with the present teachings.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the description herein, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

Insulation materials, such as fibrous structures, may have a wide range of applications, such as in automotive applications, generator set engine compartments, commercial vehicle engines, in-cab areas, construction equipment, agriculture equipment, architectural applications, flooring, floormat under-layments, and even heating, ventilating and air conditioning (HVAC) applications. Insulation materials may be used for machinery and equipment insulation, motor vehicle insulation, domestic appliance insulation, dishwashers, and commercial wall and ceiling panels. Insulation material may be used in an engine cavity of a vehicle, on the inner and/or outer dash panels, or under the carpeting in the cabin, for example. Insulation materials may also provide other benefits, such as sound absorption, compression resiliency, stiffness, structural properties, and protection (e.g., to an item around which the insulation material is located).

The present teachings envision the use of a fibrous insulative structure for providing insulation to an exhaust system of a vehicle. The insulative structure may be a multi-laver insulator material. For example, the insulative structure as described herein may be at least partially formed or wrapped around an exhaust pipe to be insulated with respect to a heat source (i.e., an exhaust) being dispelled through the pipe.

Similarly, the fibrous insulative material may be disposed along at least one or more surfaces of an exhaust pipe, may be positioned between one or more layers (e.g., walls) of an exhaust pipe, or both. For example, the exhaust pipe may be a dual-walled structure having a void therebetween. The insulative material may be located between the walls of the structure within the void to further insulate the exhaust pipe. The insulative material may be an outermost layer of the exhaust pipe free of direct contact with the exhaust being dispelled. The insulative material may be an innermost layer of the exhaust pipe having direct contact with the exhaust being dispelled. The insulative material may be shaped to conform with a shape of an exhaust pipe. That is, the insulative material may be formed to include one or more bends or the insulative material may be flexible to conform to an overall contour of the exhaust pipe. Thus, the fibrous insulative material as describe herein may be configured for various exhaust pipe packaging.

The insulative material may be formed at least partially to fill an enclosure of the exhaust pipe. The insulative material may be pre-formed and inserted into the enclosure of the exhaust pipe. The insulative material may be injected or otherwise pumped into the exhaust pipe to take the form of the exhaust pipe after insulation. The insulative material may be adapted to meet various packaging constraints of the exhaust pipe and maintain a desired material thickness. To meet such constraints, the insulative material may have a thickness of about 1 mm or more, about 4 mm or more, or about 6 mm or more. The insulative material may have a thickness of about 20 mm or less, about 15 mm or less, or about 10 mm or less. The insulative material may be moldable or otherwise shaped to allow for mechanical features to be in-situ molded or for allowing fastening or assembly mechanisms to be included, such as fastening mechanisms adapted to secure the insulative material to the exhaust pipe. The insulative material may have folding and/or bending functionality which may allow the structure to be secured around the exhaust pipe to be insulated or within the confines of a void of the exhaust pipe in which it is positioned.

The insulative material may be used as a passive heat insulation product. The insulative material may be used in combination with an active temperature control system. The insulative material may act to reduce the energy required by the active temperature control system to maintain proper temperatures throughout the exhaust system. The insulative material may allow the active temperature control system to work less, or less hard, to maintain proper exhaust system temperatures. The insulative material may help maintain, increase or minimize negative effects on heightened temperatures of the exhaust system, such as degradation of surrounding vehicle components, degradation and/or deformation of the exhaust system itself, or both. An “active temperature control system” may be, for example, an active cooling system, an active heating system, or an active heating/cooling system, all of which are within the scope of the present teachings.

The insulative material may act as a thermal and/or acoustic insulation for the exhaust pipe to protect surrounding vehicle components, to protect the surrounding vehicle environment, or both. The surrounding vehicle environment may include both an interior of the vehicle and a surrounding area outside of the vehicle cabin. As such, the insulative material may act as a barrier to protect the surrounding area from harmful heightened temperatures. Such harmful heightened temperatures may be a temperature of about 300° C. or more, about 400° C. or more, or about 500° C. or more. The heightened temperatures may be a temperature of about 1,000° C. or less, about 900° C. or less, or about 800° C. or less.

The insulative material may ensure a consistent temperature of the exhaust gases throughout the exhaust pipe. For example, it may be desired to have minimal temperature drop-off (i.e., a decrease in temperature) from an inlet of the exhaust pipe near the engine to an outlet of the exhaust pipe. The outlet of the exhaust pipe may direct the exhaust gases into a selective catalytic reduction (SCR) system to convert said emissions into N₂ and water. Maintaining a heightened temperature of the exhaust emissions may be critical to ensure the conversion of such harmful emissions into N₂ and water. As such, the insulative material may ensure minimal drop-off in temperature from the inlet to the outlet of the exhaust pipe, thereby ensuring proper conversion of the emissions. The insulative material may maintain a difference (e.g., delta) in temperature within the exhaust pipe as measured between the inlet and the outlet of the exhaust pipe of about 1° C. or more, about 3° C. or more, or about 5° C. or more. The difference in temperature may be about 10° C. or less, about 8° C. or less, or about 6° C. or less.

Similarly, the insulative material may help ensure that the exhaust pipe maintains the temperature as discussed above in different vehicle conditions. For example, the difference in temperature as stated above may be maintained when the vehicle in idling, when the engine is performing at a maximum condition, when torque of the vehicle is significantly increased, or a combination thereof. Additionally, to further ensure minimal temperature drop-off, the insulative material may help minimize leakages of the exhaust pipe. Such leakages may be any dissipation of heat energy from the exhaust gas that may reach the surrounding environment through layers of the exhaust pipe.

While vehicle exhaust systems are specifically referenced herein, it is to be understood that the insulative material disclosed herein may be used to provide insulation to other exhaust systems, and this disclosure is not limited to use with only vehicle exhaust systems. For example, other applications beyond commercial and consumer automotive vehicles may include, but are not limited to, residential and/or commercial building HVAC exhaust systems, kitchen appliance exhaust systems, generator exhaust systems, heavy-duty equipment exhaust systems, construction vehicle exhaust systems, other transportation exhaust systems (e.g., planes, trains, marine vessels, etc.), or a combination thereof.

The insulative material may function to provide insulation, acoustic absorption, structural support and/or protection to the item around which the insulative material is formed or positioned. The insulative material can be adjusted based on the desired properties. For example, the insulative material may be tuned to provide a desired weight, thickness, compression resistance, or other physical attributes. The insulative material may be tuned to provide a desired thermal conductivity. The insulative material may be tuned to withstand elevated temperatures, exposure to flame, smoke, or toxicity, or a combination thereof.

The insulative material may be formed from nonwoven fibers. The insulative material may thus be a nonwoven structure. While the insulative material may be referred to herein as a “fibrous structure,” it is contemplated that any of the individual layers may have any or all of these properties or characteristics. Also, while referred to herein as a “fibrous structure,” not all layers must be formed of fibers. It is contemplated that other materials, such as films, foils, adhesives, or other layers may be present in the insulative material.

The insulative material may be adapted to withstand high temperatures. One or more of the layers of the insulative material may have a temperature resistance of about 400° C. or greater, about 450° C. or greater, about 500° C. or greater, about 600° C. or greater, or about 700° C. or greater. One or more layers of the insulative material may have a temperature resistance of about 2500° C. or less, about 2000° C. or less, or about 1000° C. or less. The insulative material may serve as a fireblocker. The insulative material may block fire from extending beyond the enclosure of the insulative material (e.g., keeping fire from spreading should a fire be present in the exhaust pipe). The insulative material may block fire from entering the enclosure of the insulative material (e.g., keeping fire from reaching an internal portion of the exhaust pipe and the gases being emitted). The insulative material may be flame retardant. The insulative material may be non-combustible and/or may meet UL 94V-0 flammability specifications (e.g., depending upon the application, required standards, or the like).

The fibers forming any of the layers of the insulative material may be natural or synthetic fibers. Suitable natural fibers may include cotton, jute, wool, cellulose, glass, and ceramic fibers. Suitable synthetic fibers may include polyester, polypropylene, polyethylene. Nylon, aramid, imide, acrylate fibers, or combination thereof. One or more layers of the fibrous structure may comprise polyester fibers, such as polyethylene terephthalate (PET), polybutylene terephthalate (PBT), and co-polyester/polyester (CoPET/PET) adhesive bi-component fibers. The fibers may include polyacrylonitrile (PAN), oxidized polyacrylonitrile (Ox-PAN, OPAN, or PANOX), olefin, polyamide, polyetherketone (PEK), polyetheretherketone (PEEK), polyether sulfone (PES), or other polymeric fibers. The fibers may include mineral or ceramic fibers. The fibers may be formed of any material that is capable of being carded, lapped, thermobonded, thermoformed, needlepunched, air laid, or other processing methods. The fibers may be formed of any material that is capable of being formed or shaped into a three-dimensional structure. The fibers may be 100% virgin fibers or may contain fibers regenerated from postconsumer waste (for example, up to about 90% fibers regenerated from postconsumer waste or even up to 100% fibers regenerated from postconsumer waste). The fibers may have or may provide improved thermal insulation properties. The fibers may have relatively low thermal conductivity. The fibers may have geometries that are non-circular or non-cylindrical to alter convective flows around the fiber to reduce convective heat transfer effects within the three-dimensional structure. One or more layers of the insulative material may include or contain engineered aerogel structures to impart additional thermal insulating benefits.

The fibers forming one or more layers of the insulative material may include an inorganic material. The inorganic fibers may have a limiting oxygen index (LOI) via ASTM D2836 or ISO 4589-2 for example that is indicative of low flame or smoke. The LOI of the inorganic fibers may be higher than the LOI of standard binder fibers. For example, the LOI of standard PET bicomponent fibers may be about 20 to about 23. Therefore, the LOI of the inorganic fibers may be about 23 or greater. The inorganic fibers may have an LOI that is about 25 or greater. The inorganic fibers may be present in one or more of the layers of the insulative material in an amount of about 60 percent by weight or greater, about 70 percent by weight or greater, about 80 percent by weight or greater, or about 90 percent by weight or greater. The inorganic fibers may be present in one or more of the layers of the insulative material in an amount of about 100 percent by weight or less. The inorganic fibers may be selected based on its desired stiffness. The inorganic fibers may be crimped or non-crimped. Non-crimped organic fibers may be used when a fiber with a larger bending modulus (or higher stiffness) is desired. Where a fiber is needed to bend more easily, a crimped fiber may be used. The inorganic fibers may be ceramic fibers, glass fibers, mineral-based fibers, or a combination thereof. Ceramic fibers may be formed from polysilicic acid (e.g., Sialoxol or Sialoxid), or derivatives of such. For example, the inorganic fibers may be based on an amorphous aluminum oxide containing polysilicic acid. Siloxane, silane, and/or silanol may be added or reacted into one or more layers of the fibrous structure to impart additional functionality. These modifiers could include carbon-containing components.

The fibers, or at least a portion of the fibers, may have high infrared reflectance or low emissivity. At least some of the fibers may be metallized to provide infrared (IR) radiant heat reflection. An entire layer of the material may be infrared reflective. To provide heat reflective properties to and/or protect one or more of the layers of the insulative material, the fibers or one or more layers (or a portion thereof) of the insulative material may be metalized. For example, fibers may be aluminized. The fibers themselves may be infrared reflective (e.g., so that an additional metallization or aluminization step may not be necessary). The layers themselves may be infrared reflective. Metallization or aluminization processes can be performed by depositing metal atoms onto the fibers and/or one or more layers of the fibrous structure. As an example, aluminization may be established by applying a layer of aluminum atoms to the surface of fibers. Metalizing may be performed prior to the application of any additional layers one or more of the layers of the insulative material. It is contemplated that other layers of the insulative material may include metallized fibers in addition to, or instead of, having metallized fibers within the layer.

The metallization may provide a desired reflectivity or emissivity. The metallized fibers may be about 50% IR reflective or more, about 65% IR reflective or more, or about 80% IR reflective or more. The metallized fibers may be about 100% IR reflective or less, about 99% IR reflective or less, or about 98% IR reflective or less. For example, the emissivity range may be about 0.01 or more or about 0.20 or less, or 99% to about 80% IR reflective, respectively. Emissivity may change over time as oil, dirt, degradation, and the like may impact the fibers in the application.

Other coatings may be applied to the fibers, metallized or not, to achieve desired properties. Oleophobic and/or hydrophobic treatments may be added. Flame retardants may be added. A corrosion resistant coating may be applied to the metalized fibers to reduce or protect the metal from oxidizing and/or losing reflectivity. IR reflective coatings not based on metallization technology may be added.

Similarly, the fibers or one or more layers of the insulative material may be treated with one or more intumescent solutions. The intumescent solutions may expand on exposure to heat, thereby even further improving the heat and/or fire resistance of the fibrous structure. The intumescent solutions may be disposed on one or more surface of the fibrous structure. The intumescent solutions may be disposed on one or more outer surfaces, one or more inner surfaces, one or more intermediary surfaces, or a combination thereof. For example, only the outer surfaces may be treated with an intumescent solution, each layer of the insulative material may be treated with an intumescent solution, or only the inner surfaces may be treated with an intumescent solution.

One or more of the layers of the insulative material may include a binder or binder fibers. Binder may be present in one or more layers of the insulative material in an amount of about 40 percent by weight or less of the layer, about 30 percent by weight or less, about 25 percent by weight or less, or about 15 percent by weight or less. One or more of the layers of the insulative material may be substantially free of binder. One or more of the layers of the fibrous structure may be entirely free of binder. While referred to herein as fibers, it is also contemplated that the binder could be generally powder-like, spherical, or any shape capable of being received within interstitial spaces between other fibers (e.g., inorganic fibers) and capable of binding one or more of the layers of the insulative material together. The binder may have a softening and/or melting temperature of about 180° C. or greater, about 200° C. or greater, about 225° C. or greater, about 230° C. or greater, or even about 250° C. or greater. The binder may be a thermoplastic binder, a thermoset binder, or both. The fibers may be high-temperature thermoplastic materials. The fibers may include one or more of polyamideimide (PAI); high-performance polyamide (HPPA), such as Nylons; polyimide (PI); polyketone: polysulfone derivatives: polycyclohexane dimethyl-terephthalate (PCT); fluoropolymers; polyetherimide (PEI); polybenzimidazole (PBI); polyethylene terephthalate (PET); polybutylene terephthalate (PBT); polyphenylene sulfide; syndiotactic polystyrene; polyetherether ketone (PEEK); polyphenylene sulfide (PPS), polyether imide (PEI); and the like. One or more of the layers of the insulative material may include polyacrylate and/or epoxy (e.g., thermoset and/or thermoplastic type) fibers. One or more of the layers of the insulative material may include a multi-binder system. One or more of the layers of the insulative material e may include one or more sacrificial binder materials and/or binder materials having a lower melting temperature than the inorganic fibers.

One or more of the layers of the insulative material may include a plurality of bi-component fibers. The bi-component fibers may be a thermoplastic lower melt bi-component fiber. The bi-component fibers may have a lower melting temperature than the other fibers within the mixture (e.g., a lower melting temperature than common or staple fibers). The bi-component fiber may be of a flame-retardant type (e.g., formed from or including flame retardant polyester). The bi-component fibers may enable one or more of the layers of the insulative material to be air laid or mechanically carded, lapped, needlepunched, and/or fused in space as a network so that the material may have structure and body and can be handled, laminated, fabricated, installed as a cut or molded part, or the like to provide insulation properties, acoustic absorption, or both. The bi-component fibers may include a core material and a sheath material around the core material. The sheath material may have a lower melting point than the core material. The web of fibrous material may be formed, at least in part, by heating the material to a temperature to soften the sheath material of at least some of the bi-component fibers. The temperature to which one or more of the layers of the insulative material is heated to soften the sheath material of the bi-component may depend upon the physical properties of the sheath material. The bi-component fibers may be formed of short lengths chopped from extruded bi-component fibers. The bi-component fibers may have a sheath-to-core ratio (in cross-sectional area) of about 10% or more, about 20% or more, or about 25% or more. The bi-component fibers may have a sheath-to-core ratio of about 50% or less, about 40% or less, or about 35% or less.

The fibers of one or more of the layers of the insulative material may be blended or otherwise combined with suitable additives such as other forms of recycled waste, virgin (non-recycled) materials, binders, fillers (e.g., mineral fillers), adhesives, powders, thermoset resins, coloring agents, flame retardants, longer staple fibers, etc., without limitation. Any, a portion, or all of the fibers used in one or more of the layers of the insulative material could be of the low flame and/or smoke emitting type (e.g., for compliance with flame and smoke standards for transportation).

The insulative material may include a plurality of layers. One or more of the layers may include any of the fibers described herein. One or more of the layers may be free of fibers (e.g., a foil, film, adhesive, or the like). The layers may provide desired properties or characteristics. The layers, or combinations thereof, may be selected to achieve particular results. The layers may provide enhanced properties together than each layer would provide separately. Each layer of the insulative material may be a different material. The insulative material may have some layers that are the same. The insulative material may have layers with similar or same components but different densities, thicknesses, weight of material, method of distributing the fibers (e.g., lapping vs needle punching), the like, or combination thereof. The insulative material may have layers that are different. Each layer of the insulative material may be different from the layer directly adjacent. The insulative material may have one or more layers directly adjacent to another layer, where the layers are the same.

The insulative material may include a metallic or metallized layer. The layer may be located on an outermost surface of the insulative material to provide heat and/or infrared reflection. The metallic or metallized layer may be adapted to face the item to be insulated. The metallic or metallized layer may be adapted to face away from the item to be insulated (i.e., the outermost layer of the insulative material when assembled). The insulative material may include two or more metallic or metallized layers. The metallic or metallized layer may offer resistance to weathering, mold. UV, extreme environmental conditions, or a combination thereof. The material may withstand demanding temperature and humidity conditions. The material may act to seal in temperatures to reduce temperature fluctuations to which the item to be insulated is exposed. The metallic or metallized layer may act as a barrier (e.g., moisture barrier, chemical barrier, flame barrier, or the like). The metallic or metallized layer may provide support and/or reinforcement to the insulative material or one or more layers thereof. The metallic or metallized layer may provide protection to other layers of the insulative material (e.g., by providing puncture resistance). The metallic or metallized layer may resist failure from common sources of degradation, including moisture, UV rays, extreme temperature conditions, and chemicals.

The metallic or metallized layer may be a foil, coating, sheet, deposition of metal atoms on a surface of a material, or the like. The metallic or metallized layer may be reinforced (e.g., with ribs). The metallic layer may have one or more substantially smooth surfaces, one or more embossed surfaces, or both. The metallic or metallized layer may be reinforced, for example, by wire, fibers, additives, mesh, or the like. The metallic or metallized layer may be formed of a metal or metal alloy. For example, the metallic or metallized layer may be formed of aluminum (e.g., an aluminum foil), stainless-steel (e.g., a stainless-steel foil such as SS-304 or SS-430), or both.

The metallic or metallized layer may have a thickness sufficient to provide the desired properties or protection. The metallic or metallized layer may have a thickness of about 50 micrometers or greater, about 100 micrometers or greater, or about 150 micrometers or greater. The metallic or metallized layer may have a thickness of about 250 micrometers or less, about 200 micrometers or less, or about 150 micrometers or less.

The insulative material may include one or more layers having fibers capable of withstanding high temperatures. The insulative material may include one or more layers having fibers that do not burn, melt, soften, and/or drip. The fibers may provide effective protection against fire and/or heat. The insulative material may include one or more layers having fibers that are resistant to many or most solvents and chemicals. The insulative material may include one or more layers having fibers with a low permeability to gases.

Fibers capable of withstanding high temperatures may be organic fibers. The fibers may be formed of or include a synthetic thermoplastic polymer resin. For example, the fibers may be polyacrylonitrile fibers. The polyacrylonitrile fibers may be oxidized polyacrylonitrile fibers, such as Ox-PAN, OPAN, or PANOX.

The one or more layers may include polyacrylonitrile fibers or oxidized polyacrylonitrile fibers in the layer in an amount of about 50 wt % or greater of the layer, about 70 wt % or greater, or about 75 wt % or greater. The one or more layers may include polyacrylonitrile fibers or oxidized polyacrylonitrile fibers in an amount of about 100 wt % or less. The layer may include other components, such as other thermoplastic polymer materials. The layer may comprise polyester fibers, such as polyethylene terephthalate (PET), polybutylene terephthalate (PBT), and co-polyester/polyester (CoPET/PET) adhesive bi-component fibers. The fibers may include olefin, polyamide, polyetherketone (PEK), polyetheretherketone (PEEK), polyether sulfone (PES), or other polymeric fibers. The fibers may include mineral or ceramic fibers. For example, the material may contain about 70 wt % polyacrylonitrile fibers or about 70 wt % oxidized polyacrylonitrile fibers and up to about 30 wt % PET.

The fibers, such as polyacrylonitrile fibers (which may be or may include oxidized polyacrylonitrile fibers), may be used to form a nonwoven layer. The fibers forming the nonwoven layer may be formed into a nonwoven web using nonwoven processes including, for example, blending fibers, carding, lapping (e.g., vertical lapping, cross-lapping), thermobonding, air laving, mechanical formation, needle punching, or a combination thereof. The layer may have a weight of about 100 g/m² or greater, about 200 g/m² or greater, or about 400 g/m² or greater. The layer may have a weight of about 100 g/m² or less, about 750 g/m² or less, or about 500 g/m² or less.

The insulative material may include two or more layers having these polyacrylonitrile fibers. The layers may be the same relative to each other. The layers may be different relative to each other (e.g., by structure of the nonwoven material, orientation of the fibers, weight of the material, or the like). The insulative material may include some layers that are the same and some layers that are different.

For example, an insulative material may include one or more polyacrylonitrile or oxidized polyacrylonitrile fiber layers formed by needle punching. The needle-punched layer may have a weight of about 100 g/m² to about 1,500 g/m². The insulative material may include one or more polyacrylonitrile or oxidized polyacrylonitrile fiber layers formed by cross-lapping. The cross-lapped layer may have a weight of about 200 g/m² to about 400 g/m². The insulative material may include two or more needle-punched layers of polyacrylonitrile or oxidized polyacrylonitrile fibers. The insulative material may include two or more cross-lapped layers of polyacrylonitrile or oxidized polyacrylonitrile fibers. The insulative material may include a combination of needle-punched and cross-lapped polyacrylonitrile or oxidized polyacrylonitrile fiber layers.

The insulative material may include one or more layers having inorganic fibers or fibers made from inorganic materials. These fibers may be capable of withstanding high temperatures, provide thermal stability, or both. One or more layers or the fibers therein may be non-combustible. One or more layers or the fibers therein may have high-porosity, provide acoustic absorption, or a combination thereof. One or more layers or the fibers therein may exhibit high temperature duration, low heat shrinkage, low heat loss, or a combination thereof.

One or more layers of the insulative material having inorganic fibers may have up to 100 wt % of the layer inorganic fibers. One or more layers of the insulative material may have inorganic fibers in an amount of about 50 wt % or greater of the layer, about 70 wt % or greater, or about 90 wt % or greater.

The insulative material may include one or more layers including E-glass. The fibers forming the E-glass layer may resist thermal expansion, which may keep the shape and size of the layer constant despite exposure to temperature fluctuations. The fibers may provide high strength and stiffness at low weight. The fibers may exhibit low values for dielectric constant, dielectric loss, or both. The fibers, or layer formed by the fibers, may have a temperature resistance up to and including about 500° C., about 600° C., or about 640° C., or even higher.

The E-glass layer may include any of silica, alumina, calcium oxide (CaO), boron oxide (B2O3). The E-glass inorganic materials may be enveloped by a resin, such as an epoxy resin. The layer may be formed by any suitable process, including but not limited to needle punching to form a mat.

The E-glass fibers may be free of boron oxide. Such boron-free material is referred to as E-CR glass. The E-CR glass may provide acid and/or chemical resistance. The E-CR glass may provide increased temperature resistance. The fibers, or layer formed by the fibers, may have a temperature resistance up to and including about 600° C., about 650° C., or about 700° C., or even higher. An E-CR glass layer may be formed by any suitable process, including but not limited to needle punching to form a mat.

The insulative material may include one or more layers having fibers forming a high-silica nonwoven material. The layer may be formed by any suitable process, including but not limited to needle punching to form a mat. The layer may be formed by silica fibers in any amount up to 100 wt % of the layer.

The insulative material may include one or more layers of a ceramic blanket or paper. The ceramic blanket or paper layer may provide improved handling strength, enhanced thermal properties, or both. The ceramic blanket or paper layer may exhibit outstanding insulating properties at elevated temperatures. The ceramic blanket or paper layer may have excellent thermal stability. The ceramic blanket or paper may be flexible, easy to cut and shape, or a combination thereof. The ceramic blanket or paper may have good resistance to tearing. The ceramic blanket may exhibit low heat storage. The ceramic blanket or paper may provide sound absorption. The ceramic blanket or paper layer may be formed by any suitable process, including but not limited to needle punching. Similarly, the ceramic blanket or paper may include one or more binders to form the ceramic blanket or paper.

The ceramic blanket or paper may be substantially free of binder (e.g., about 1 wt % or less of the layer). The ceramic blanket or paper may be entirely free of binder. The ceramic blanket or paper may be formed of inorganic materials in an amount up to and including about 100 wt % of the layer. For example, the ceramic blanket or paper may comprise silicon dioxide (SiO₂), calcium oxide (CaO), and magnesium oxide (MgO). One particular ceramic blanket or paper may be a Superwool® blanket or paper.

The insulative material may include one or more layers of fiberglass. For example, one or more of the layers may be black glass cloth. The fiberglass may impart high temperature resistance and thermal stability. The fiberglass layer may provide abrasion resistance. The fiberglass layer may be resistant to tearing. The fiberglass layer may exhibit solvent resistance.

The nonwoven materials of the present teachings may be formed using any method that produces a material having the desired properties. This is including, but not limited to, carding, air laying, wet laying, spun-bonding, melt-blowing, electro-spinning, lapping (e.g., vertically lapping, cross-lapping), needle punching, or any combination thereof.

The present teachings contemplate any combination of layers described herein, including but not limited to: a metallic layer, such as stainless-steel (e.g., SS-304 or SS-430) or an aluminized laver: a polyacrylonitrile fiber-based or oxidized polyacrylonitrile fiber-based layer (formed by any process, such as needle punching and/or lapping, such as cross-lapping); and inorganic fiber layer formed from E-glass, E-CR glass, a high silica nonwoven, fiberglass, ceramic blanket.

The layers of material forming the insulative material may be secured together to create the finished insulative material. One or more layers may be bonded together by elements present in the layers. For example, binder fibers in one or more layers may serve to bond layers together. The outer layers (i.e., the sheath) of bi-component fibers in one or more layers may soften and/or melt upon the application of heat, which may cause the fibers of the individual layers to adhere to each other and/or to adhere to the fibers of other layers. Layers may be attached together by one or more lamination processes. One or more adhesives may be used to join two or more layers. The adhesives may be a powder or may be applied in strips, films, sheets, or as a liquid, for example. The one or more layers may be secured to each other using any other process suitable for the intended use, such as stitching, mechanical bonding, heat sealing, sonic or vibration welding, pressure welding, the like, or a combination thereof.

The total thickness of the insulative material may depend upon the number and thickness of the individual layers. The insulative material may have 2 or more layers, 3 or more layers, or 4 or more layers. The insulative material may have 10 or less layers, 8 or less layers, or 6 or less layers. Thus, it envisioned that the number of layers may be selected based on a desired application, packaging constraints, performance requirements, or a combination thereof.

Similarly, it is envisioned that, based upon a given application, the one or more materials of the insulative material may be provided in a number of forms. For example, the insulative material may be provided in a pre-formed or molded shape for the exhaust pipe. Similarly, the insulative material may be provided as a powder or slurry for injection or pumping into the exhaust pipe. The slurry may include a coating (e.g., a CaCO3 coating), may include a paste, or both. Thus, the one or more materials as described above may be mixed into such a slurry or powder to create a resultant insulative material layer in the exhaust pipe. For example, a slurry may include one or more inorganic fiber materials, one or more binders, one or more organic materials, or a combination thereof.

Additionally, it is envisioned that the insulative material may be pre-formed and applied to the exhaust pipe in a manner other than molding. For example, the insulative material include a wet-laid material at least partially surrounding a cutout of material to substantially form the insulative material. Such a manufacturing process may fill and/or surround a dry cutout of material with the wet-laid insulative material. The structure forming the insulative material (i.e., a cutout surrounded by wet-laid material) may then be stitched or otherwise sealed prior to application to the exhaust pipe. That is, an inner wall of an exhaust pipe may be wrapped by the structured layers of concealed wet-laid insulative material having the cutout material prior to an outer wall of the exhaust pipe being assembly on an opposing side of the insulative material. Thus, it may be gleaned that a variety of manufacturing techniques may be applied to create the insulated exhaust pipe taught herein.

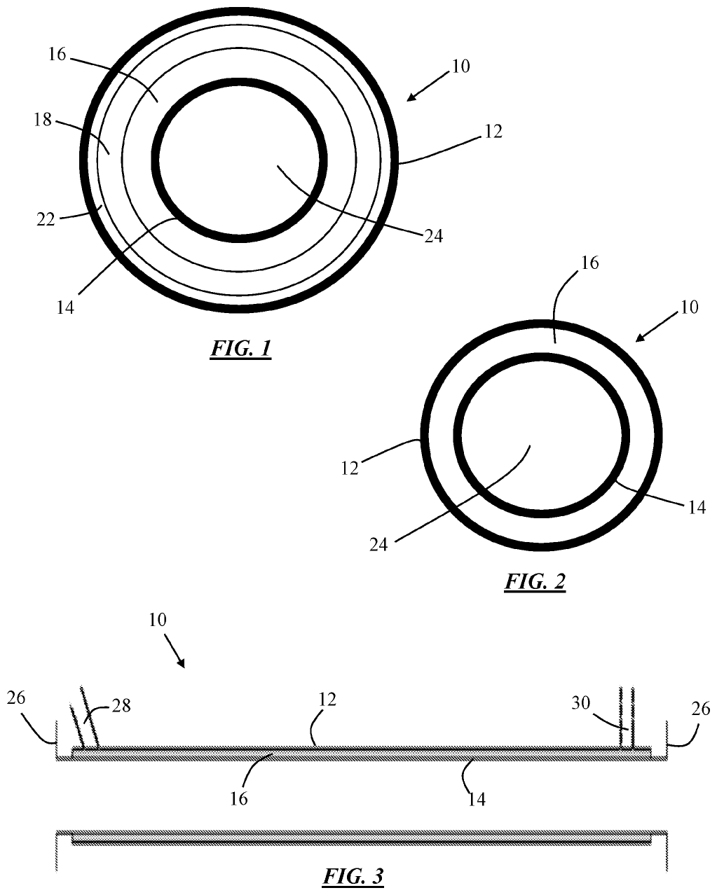

Turning now to the figures, FIG. 1 illustrates a sectional view of an exhaust pipe 10 in accordance with the present teachings. The exhaust pipe 10 may include an outer wall 12 and an inner wall 14. The inner wall 14 may guide or otherwise contain an exhaust gas from an engine. That is, an inner surface of the inner wall 14 may be in direct contact with a heat source 24 created by the exhaust traveling through the pipe 10. Conversely, the outer wall 12 of the exhaust pipe 10 may be free of direct contact with the heat source 24.

The outer wall 12 and the inner wall 14 may be offset any desired distance to create a space therebetween. This is, while the outer wall 12 may have a diameter greater than a diameter of the inner wall 14, any diameters may be utilized for the exhaust pipe 10 based on vehicle requirements, industry standards, testing standards, or a combination thereof. Similarly, while the outer wall 12 and the inner wall 14 are shown to be concentric along a central axis, the outer wall 12 may be offset the inner wall 14, or vice versa, so that a gap between the outer wall 12 and the inner wall 14 may vary.

The gap between the inner wall 14 and the outer wall 12 may include one or more additional layers. The one or more additional layers may be adapted to improve insulation from the heat source 24, may improve structural integrity (e.g., rigidity, stiffness, etc.), may provide noise attenuation, or a combination thereof. As such, a single material or a plurality of materials may be implemented in the exhaust pipe 10 to even further tune characteristics of the exhaust pipe 10.

Adjacent to the outer surface of the inner wall 14 may be an insulative material 16. The insulative material 16 may be a variety of one or more materials configured to further insulate the exhaust pipe 10 from the heat source 24. For example, the insulative material 16 may be a multi-layered fibrous material adapted to manage thermal dissipation caused by the heat source 24. However, it is envisioned that a number of configurations may be implemented for the insulative material 16.

The insulative material 16 may be directly secured to the outer surface of the inner wall 14 to better insulate the exhaust pipe 10. The insulative material 16 may contain an adhesive that may be cured or otherwise activated to adhere the insulative material 16 directly to the inner wall 14. The adhesive of the insulative material 16 may be fully or partially integrated into the insulative material 16, such that the adhesive is present throughout a thickness of the insulative material 16. Similarly, the insulative material 16 may contain a surface layer of adhesive that is present along a contact surface the abuts the inner wall 14, thereby forming a bond between the inner wall 14 and the insulative material 16. However, it should be noted that the insulative material 16 may also be free of an adhesive in certain situations. For example, the outer surface of the inner wall 14 may include an adhesive to secure the insulative material 16. Additionally, as may gleaned from the present teachings, the adhesive utilized to secure the insulative material 16 (or any additional materials as described herein) may be adapted for high-temperature applications to withstand the heat source 24 and maintain a bond during operation of the exhaust system.

An opposing side of the insulative material 16 (i.e., an outer surface) that is free of contact with the inner wall 14 may abut an interface layer 18. The interface layer 18 may be an additional layer of material secured to the outer surface of the insulative material 16. Similarly, the interface layer 18 may be an outermost surface layer of the insulative material 16. That is, the interface layer 18 may be integrally formed with the insulative material 16 to create a surface of the insulative material 16. As such, the interface layer 18 may be formed with the insulative material 16 or otherwise secured (e.g., adhered, mechanically interlocked, etc.) to the insulative material 16 to at least partially enclose the insulative material 16.

The interface layer 18 may be spaced apart from the outer wall 12 of the exhaust pipe 10 to form an air gap 22 therebetween. The air gap 22 may be present along an entire circumference of the interface layer 18 or may be present in localized regions. Moreover, it is envisioned that the air gap 22 may be maintained during operation of the exhaust system so that a space is consistently present between the interface layer 18 and the outer wall 12 to even further manage the heat created by the heat source 24.

FIG. 2 illustrates a sectional view of an exhaust pipe 10 in accordance with the present teachings. As may be seen in FIG. 2, the structure of the exhaust pipe 10 may differ from that described above with respect to FIG. 1. Thus, the present teachings may beneficially provide for a variety of configurations to meet the demands of a given application. For example, it is envisioned that the insulative techniques and structures described herein may be utilized to retrofit or otherwise integrate into an existing exhaust pipe structure. The insulative materials or additional material layers may be inserted into the exhaust pipe free of significant manufacturing changes or cost implications.

With respect to FIG. 2, the exhaust pipe 10 may include an outer wall 12 and an inner wall 14. As discussed above, the inner wall 14 may substantially contain the heat source 24 of an exhaust being expelled through the exhaust pipe 10. An insulative material 16 may be positioned between the outer wall 12 and the inner wall 14 to fill a cavity formed between the outer wall 12 and the inner wall 14. It is envisioned that the insulative material 16 may contact or be secured (e.g., adhered, mechanically interlocked, etc.) to both the inner wall 14 and the outer wall 12 to form an air-tight seal between the inner wall 14 and the outer wall 12. That is, an air gap may advantageously be removed from the space between the inner wall 14 and the outer wall 12.

FIG. 3 illustrates a sectional view of an exhaust pipe 10 during a manufacturing process. As discussed above, the exhaust pipe 10 may include an inner 14 wall and an outer wall 12, whereby an insulative material 16 may be disposed between the inner wall 14 and the outer wall 12. Additionally, the exhaust pipe 10 may beneficially be free of an air gap present between the inner wall 14 and the outer wall 12.

To facilitate removal of the air gap, the exhaust pipe 10 may be secured to a fixture 26 via one or more flanges (not shown) during the manufacturing process. It should be noted that the methodology described herein may be implemented in an existing manufacturing process for exhaust pipes 10, may be an additional process, or a combination thereof. Similarly, the fixture 26 may be any point along the manufacturing process that provides an opportunity for removal of the air gap.

An inlet 28 and an outlet 30 may be secured or otherwise connected to the outer wall 12 of the exhaust pipe 10. The inlet 28 and the outlet 30 may provide additional piping or tubing into or from the exhaust pipe 10. It is envisioned that the inlet 28 and the outlet 30 may penetrate the outer wall 12 to reach the space between inner wall 14 and the outer wall 12. Similarly, to avoid additional apertures or holes being cut into the outer wall 12 of the exhaust pipe 12, the inlet 28 and the outlet 30 may be positioned near terminal ends of the pipe 10 where a cap or closing will enclose the exhaust pipe 10.

The inlet 28 may be configured to pump the insulative material 16 into the void between the outer wall 12 and the inner wall 14. The insulative material 16 may be pumped into the exhaust pipe 10 as a slurry, paste, power, or a combination thereof to fill the void between the outer wall and the inner wall 14. Advantageously, the insulative material 16 may be sufficiently viscous so that pumping through the outlet 28 may allow the insulative material 16 to reach all portions of the void between inner wall 14 and the outer wall 12. Thus, the insertion method of pumping may be minimally invasive within the exhaust pipe 10.

Once the void has been sufficiently filled with the insulative material 16, any remaining air may be vacuumed out of the space between the inner wall 14 and the outer wall 12 to remove any potential air gap therein. The vacuuming may be completed using the outlet 30. Beneficially, the outlet 30 may remove the air during the vacuuming process yet leave the insulative material 16 undisturbed. As a result of the vacuuming, the insulative material 16 may form an air-tight seal between the outer wall 12 and the inner wall 14 to provide an optimized insulative layer 16.

Additionally, it should also be noted that an air-tight insulation may also be present with one or more additional steps beyond vacuuming out the air. For example, the vacuuming may remove excess air from the void and compress the insulative material 16 to an optimal thickness. However, a physical space may still be present between the outer wall 12 and/or the inner wall 14 and the insulative material 16. To determine such a level of vacuum-sealing, one or more pieces of equipment, such as a mercury-based vacuum level measurement, may be implemented into the manufacturing process. As a result, an operator may be able to specifically tune the insulative material 16 even further for specific application.

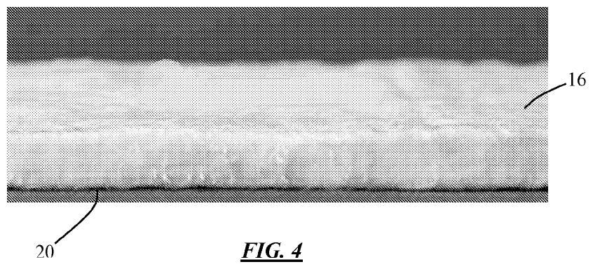

FIG. 4 illustrates a perspective view of an insulative layer 16 in accordance with the present teachings. As discussed above, the insulative layer 16 may be a single layer of material or may be a plurality of layers. The insulative layer 16 may be lofted or compressed. The insulative layer 16 may contain one or more varieties of fibers. The insulative layer 16 may be nonwoven. As such, it may be gleaned that the insulative layer 16 may be highly adapted for a variety of packaging demands.

The insulative layer 16 may also contain one or more surface layers 20. As discussed above, the surface layers 20 may be an interface layer between the insulative material 16 and an air gap, between the insulative material 16 and one or more walls of the exhaust pipe 10, or both. The insulative layer 16 may be a facing layer of the insulative material 16 to provide a reflective surface. For example, the insulative layer 16 may be a metallic material. Additionally, the surface layer 20 may include one or more patterns, such as one or more embossments, one or more undulations, one or more apertures and/or cutouts, one or more grooves, or a combination thereof. Such a surface layer 20 may be adhered or otherwise secured to the insulative material 16.

### Illustrative Examples

Table 1 below illustrates thermal conductivity between the exhaust pipe insulative structure in accordance with the present teachings (Sample 1) and a conventional exhaust pipe insulative structure (Sample 2). Both samples include a double-walled exhaust pipe structure. However, Sample 1 includes an insulative material layer as described above having a facing layer. Additionally, Sample 1 includes an interface layer as well. The insulative material layer and the interface layer are both positioned between the outer and inner walls of the exhaust pipe. Dissimilarly, Sample 2 includes an insulative layer of different materials and a surface layer thereof free of an interface layer. Additionally, it should be noted that Sample 1 also beneficially included a material thickness of about 6 mm while Sample 2 had a material thickness of about 12 mm.

TABLE 1

| | |
|---|---|
| Sample 1 | Sample 2 |

| | | | |
|---|---|---|---|
| Thickness | 6 mm | Thickness | 12 mm |
| Temperature | K | Temperature | K |
| (Degrees C.) | (W/m-K) | (Degrees C.) | (W/m-K) |
| 22.5 | 0.021 | 22.5 | 0.027 |
| 150 | 0.031 | 100 | 0.041 |
| 300 | 0.045 | 300 | 0.063 |
| 500 | 0.065 | 500 | 0.083 |

As shown in Table 1 above, Sample 1 surprisingly provided better thermal conductivity performance when compared to Sample 2 even though Sample 1 had a thickness of about half the thickness of Sample 2.

Table 2 below illustrates a change in temperature (Delta T) measurement for various test conditions and structures. The structures include vacuumed or not (i.e., air gap present or not), having an outer wall (i.e., outer pipe). Two samples (Pipe 1 and Pipe 2) were tested.

TABLE 2

| | | Pipe 1 | Pipe 2 |
|---|---|---|---|
| Test conditions | | 200 Deg C. at 135 | 200 Deg C. at 135 |
| | | kg/hr flow rate | kg/hr flow rate |
| Description | | Delta T, in Deg C. | Delta T, in Deg C. |
| Bare Pipe | | 30 to 32 | 30 to 32 |
| Pipe with insulation | | 11 to 12 | 11 to 12 |
| Pipe with insulation and | | 11 to 12 | 9 to 11 |
| outer pipe. Without | | | |
| vacuum Without | | | |
| bellow insulation. | | | |
| Pipe with insulation and | Air Cavity | 9 to 10 | 8 to 9 |
| outer pipe. Without | | | |
| vacuum (Air Cavity) With | | | |
| bellow insulation. | | | |
| Pipe with insulation and | 25 inch to Mercury | 7 to 8 | 6 to 7 |
| outer pipe. With vacuum | | 5 to 6 | 4 to 5 |
| (25 inch in Mercury) | | | |
| Without bellow insulation | | | |
| Pipe with insulation and | Air Cavity | 9 to 10 | 8 to 9 |
| outer pipe. Without | | | |
| vacuum With bellow | | | |
| insulation | | | |
| Pipe with insulation and | 10 inch Mercury | 7 to 8 | 6 to 7 |
| outer pipe. With vacuum | 15 inch Mercury | 7 to 8 | 6 to 7 |
| (25 inch in Mercury) With | 20 inch Mercury | 7 to 8 | 6 to 7 |
| bellow insulation | 25 inch Mercury | 5 to 6 | 4 to 5 |
| | 30 inch Mercury | 5 to 6 | 4 to 5 |

Table 3 below illustrates temperature measurements for various test conditions and structures for a 1.9 m profile pipe. The structures included insulation having a 6 mm thickness and a 12 mm thickness, the 6 mm thickness including both an air gap and being free of an air gap. The testing was conducted at various temperatures and pressure conditions.

TABLE 3

| | | | Physical Test | FlowEfd Result | Star CCM Result |
|---|---|---|---|---|---|
| Pipe | Test Condition | Construction | deg C. | deg C. | deg C. |
| 1.9 m | 200 deg C. @ 135 kg/hr | Bare | 30 to 32 | 30 | 31 |
| Profile Pipe | Atmospheric Pressure | 6 mm Insulation | 11 to 12 | 10.6 | 9.6 |
| | | 6 mm Insulation with Outer Pipe | 9 to 10 | 9 | 6 |
| | | (Air Cavity) | | | |
| | | 6 mm Insulation with Outer Pipe | 5 to 7 | 7.3 | 4 |
| | | (Vacuum Cavity) | | | |
| | | 12 mm Insulation | 13 to 15 | 13.5 | — |
| | 375 deg C. @ 189 kg/hr | Bare | — | — | 36 |
| | 30 KPa Back pressure | 6 mm Insulation | — | — | 16.4 |
| | | 6 mm Insulation with Outer Pipe | — | — | 11.7 |
| | | (Air Cavity) | | | |
| | | 6 mm Insulation with Outer Pipe | — | — | 8.8 |
| | | (Vacuum Cavity) | | | |
| | 168.3 kg/hr @ 400° C. | 12 mm Insulation | 16 at Cummins | 17.1 | — |

Table 4 below illustrates a change in temperature (Delta T) measurement for a 1.9 meter straight exhaust pipe evaluated along the length of the pipe. The insulative material was pumped into a void between the inner and outer wall of the exhaust pipe as a paste. The inner wall had a diameter of about 81.2 mm while the outer wall had a diameter of about 101.6 mm.

TABLE 4

| | Insulation paste pumping between |
|---|---|
| | inner and Outer cavity |
| Test Conditions | 200 Deg C. at 195 kg/hr flow rate |
| Description | Delta T, In Deg C. |
| Weight of Insulation | 2.10 kg |
| Bare Pipe | 35 o 37 |
| Pipe with insulation | NA |
| Pipe with insulation and outer pipe. | 4 to 5 |
| Without vacuum. | |
| Pipe with insulation and outer pipe. | 2 to 3 |
| With vacuum. (25 inch in mercury) | |

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner.” “outer.” “beneath.” “below.” “lower.” “above.” “upper.” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The disclosures of all articles and references, including patent applications and publications, are incorporated by reference for all purposes. Other combinations are also possible as will be gleaned from the following claims, which are also hereby incorporated by reference into this written description.

Unless otherwise stated, a teaching with the term “about” or “approximately” in combination with a numerical amount encompasses a teaching of the recited amount, as well as approximations of that recited amount. By way of example, a teaching of “about 100” encompasses a teaching of within a range of 100+/−15.

### ELEMENT LIST

10 Exhaust Pipe
12 Outer Wall
14 Inner Wall
16 Insulative Material
18 Interface Layer
20 Surface Layer
22 Air Gap
24 Heat Source
26 Fixture
28 Inlet
30 Outlet

1. An article comprising a plurality of layers, the layers comprising:
one or more nonwoven layers;
wherein each of the one or more nonwoven layers has a temperature resistance of about 800° C. or greater; and
wherein the article is adapted to provide thermal insulation for an exhaust pipe; and
wherein the article is optionally adapted to be injected into the exhaust pipe as a slurry or a powder.

2. The article of claim 1, wherein the exhaust pipe is a dual-walled pipe having an outer wall and an inner wall spaced apart from the outer wall.

3. The article of claim 2, wherein the article is positioned between the outer wall and the inner wall.

4. The article of claim 2, wherein the article abuts an outer surface of the inner wall.

5. The article of claim 2, wherein the article is spaced apart from an inner surface of the outer wall by an air gap.

6. The article of claim 2, wherein the article abuts an inner surface of the outer wall.

7. The article of claim 2, wherein the article forms an airtight seal between the outer wall and the inner wall.

8. The article of claim 1, wherein the article is injected into the exhaust pipe as a slurry.

9. The article of claim 1, wherein the article is preformed and inserted into the exhaust pipe.

10. An exhaust pipe comprising:
(A) an inner wall;
(B) an outer wall spaced apart from the inner wall; and
(C) an insulative material positioned between the inner wall and the outer wall, wherein the insulative material includes one or more nonwoven layers and has a temperature resistance of about 800° C. or greater.

11. The exhaust pipe of claim 10, wherein the insulative material abuts an outer surface of the inner wall.

12. The exhaust pipe of claim 11, wherein the insulative material abuts an inner surface of the outer wall.

13. The exhaust pipe of claim 10, wherein the insulative material forms airtight seal with the outer wall and the inner wall.

14. The exhaust pipe of claim 10, wherein a fluid high temperature-resistant adhesive is injected between the outer wall and the inner wall to fill any cavity formed therebetween.

15. The exhaust pipe of claim 10, wherein the insulative material is a slurry of material injected between the inner wall and the outer wall.

16. The exhaust pipe of claim 10, wherein the insulative material includes one or more surface layers.

17. The exhaust pipe of claim 16, wherein the one or more surface layers is a metallic material.

18. The exhaust pipe of claim 10, wherein the insulative material is spaced apart from the outer wall by an air gap.

19. The exhaust pipe of claim 10, wherein the insulative material has a thickness of about 5 mm to about 7 mm.

20. The exhaust pipe of claim 10, wherein the exhaust pipe maintains a temperature along a length of the exhaust pipe during operation of within about 7° C.

21-30. (canceled)
